(19) United States
(12) Patent Application Publication
(10) Pub. No.: US 2007/0215523 A1
(43) Pub. Date: Sep. 20, 2007

(54) Dilute phosphorus incorporation into a naphtha reforming catalyst

(76) Inventors: Mark D. Moser, Des Plaines, IL (US); Michael H. Quick, Des Plaines, IL (US); Margo W. Steward, Des Plaines, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 10/316,224

(22) Filed: Dec. 10, 2002

(51) Int. Cl. C10G 35/00; C10G 35/06; B01J 23/42; B01J 27/13; B01J 27/185; B01J 27/00

(52) U.S. Cl. 208/133; 208/137; 208/138; 208/139; 502/208; 502/213; 502/230; 502/334

(57) ABSTRACT

In order to maintain the surface area of an alumina catalyst over the course of operation and regeneration, a method of incorporating phosphorus into the alumina has been developed. By incorporating a small amount of phosphorus, the resulting catalyst is better able to withstand hydrothermal conditions, such as during a carbon burn step, which causes alumina surface area to degrade or decrease. Reduced surface area also desorbs chloride from the catalyst, lowering activity and increasing corrosion. Here, steam treatments have been used to simulate commercial hydrothermal stability and a critically small amount of phosphorus has been discovered which balances an increased surface area against decreased chloride retention. Increased surface area results from increased phosphorus, yet higher levels of phosphorus blocks ability to hold chloride. Moreover, X-ray data shows that an amount as low as 0.2 wt-% phosphorus increases alumina transition temperature, while pilot plant data shows excellent naphtha reforming yields.

### FIELD OF THE INVENTION

This invention relates to a process for preparing a catalyst for naphtha reforming, the catalyst itself, and a naphtha reforming process using the catalyst. The catalyst is prepared by using dilute phosphoric acid to create a gamma alumina support with improved surface area retention and improved halogen retention.

### BACKGROUND OF THE INVENTION

Catalytic reforming of naphtha involves a number of competing processes or reaction sequences. These include dehydrogenation of cyclohexanes to aromatics (benzene), dehydroisomerization of alkylcyclopentanes to alkylaromatics, dehydrocyclization of an acyclic hydrocarbon to aromatics, hydrocracking of paraffins to light products boiling outside the gasoline range, dealkylation of alkylbenzenes and isomerization of paraffins. Some of the reactions occurring during reforming, such as hydrocracking which produces light paraffin gases, have a deleterious effect on the yield of products boiling in the gasoline range. Process improvements in catalytic reforming thus are targeted toward enhancing those reactions effecting a higher yield of the gasoline fraction at a given octane number.

It is of critical importance that a catalyst exhibits the capability both to initially perform its specified functions efficiently and to perform them satisfactorily for prolonged periods of time. The parameters used in the art to measure how well a particular catalyst performs its intended function in a particular hydrocarbon reaction environment are activity, selectivity and stability. In a reforming environment, these three parameters are defined as follows: (1) Activity is a measure of the ability of the catalyst to convert hydrocarbon reactants to products at a designated severity level, with severity level representing a combination of reaction conditions: temperature, pressure, contact time, and hydrogen partial pressure. Activity typically is characterized as the octane number of the pentanes and heavier (“C₅⁺”) product stream from a given feedstock at a given severity level or conversely as the temperature required to achieve a given octane number. (2) Selectivity refers to the percentage yield of petrochemical aromatics or C₅⁺ gasoline product from a given feedstock at a particular activity level. (3) Stability refers to the rate of change of activity or selectivity per unit of time or of feedstock processed. Activity stability generally is measured as the rate of change of operating temperature per unit of time or of feedstock to achieve a given C₅⁺ product octane, with a lower rate of temperature change corresponding to better activity stability, since catalytic reforming units typically operate at relatively constant product octane. Selectivity stability is measured as the rate of decrease of C₅⁺ product or aromatics yield per unit of time or of feedstock. Hydrothermal stability refers to the ability of a catalyst to withstand extended conditions associated with commercial operation and periodic regeneration to remove accumulated coke deposits. Coke deposits are a well-known cause of catalyst deactivation and are typically removed through exothermic combustion. Such periodic regeneration most frequently results in surface area decline and reduced support capacity to hold anions such as chloride. Thus, a steam treatment test to study surface area decline can be useful in simulating long-term hydrothermal stability over prolonged periods of time.

Programs to improve performance of reforming catalysts are being stimulated by the reformulation of gasoline and related refinery demands for constant hydrogen supply. Gasoline-upgrading processes such as catalytic reforming must operate at higher efficiency with greater flexibility in order to meet these changing requirements. The major problem facing workers in this area of the art, therefore, is to develop catalysts with more stability, activity, and selectivity.

U.S. Pat. No. 2,890,167 to Haensel broadly discloses a gasoline reforming process in the presence of a phosphorus containing platinum group metal catalyst. However, there is no mention of alumina phase, alumina surface area, catalyst chloride range, feedstock chloride range, and resulting catalyst chloride retention. Nor is there any mention to the benefits achieved by dilute phosphorus incorporation and the resulting beneficial percent equivalent anionic capacity of the catalyst.

U.S. Pat. No. 4,483,767 to Antos et al. discloses catalytic reforming with a platinum group composition also containing phosphorus. The catalyst is made by compositing a platinum group component with a porous support material and then contacting that composite with a compound of phosphorus. Such a two-step catalyst shows best results with about 0.5 wt-% phosphorus and about 1.0 wt-% chloride on gamma-alumina.

U.S. Pat. No. 5,972,820 to Kharas et al. discloses methods of stabilizing crystalline delta phase alumina compositions, including specific compositions with an effective lower limit of 1.0 wt-% phosphorus.

Contrary to the teachings of Kharas et al., it has surprisingly been discovered that a method incorporating a dilute amount of phosphorus (clearly less than 1.0 wt-%) into a gamma alumina support creates a stabilized catalyst with superior surface area retention and chloride retention. The catalyst more effectively utilizes the support's equivalent anionic capacity with a balanced range of at least some phosphorus to a maximum of about 0.4 wt-% phosphorus. Moreover, a catalytic reforming process with such a catalyst has longer over-all life with reduced chloride consumption and consequent corrosion resistance and improved economics. Over-all life of a reforming catalyst is typically considered to be near the end of its useful life once the surface area has declined below 150 m²/gm. Excessive chloride consumption occurs with lower levels of surface area where catalysts lose part of their ability to retain chloride species, and thus a minimum useful chloride retention level for a reforming catalyst is typically considered to be about 0.8 wt-%. Such chloride provides acidity function to the catalyst which facilitates isomerization and cracking reactions which participate in allowing the catalyst to transform a low octane feed into a high octane product.

### SUMMARY OF THE INVENTION

This invention relates to a process for preparing a catalyst with balanced surface area and chloride retention. The invention also relates to the catalyst itself and to a process using the catalyst, preferably a catalytic naphtha reforming process. Accordingly, the catalyst is based upon an alumina support having a phosphorus component in an amount greater than 0 wt-% and less than 0.4 wt-%. Preferably the phosphorus content of the catalyst varies from about 0.05 wt-% to about 0.35 wt-%. The catalyst is characterized in that after hydrothermal steaming with air at 40 mol-% water for 6 hours at 725° C., the catalyst retains a useful surface area greater than about 150 m²/gm and retains an equilibrium level of chloride absorption greater than about 0.8 wt-%. The process for preparing the catalyst includes adding a peptizing acid comprising dilute phosphoric acid to an alumina powder to form dough. After mixing and extruding the dough to form extrudate particles, the particles are then calcined at conditions comprising a temperature between about 300° and about 850° C. for a time of about 30 minutes to about 18 hours. The alumina powder may also comprise an alumina modifier such as boron, titanium, silicon, or zirconium.

In order to be effective as a reforming catalyst, this invention will have a platinum group component, an optional metal modifier component, and a halogen component in addition to the phosphorus component. The catalyst should also contain at least 90 wt-% gamma phase alumina. Therefore, a reforming process using the catalyst will comprise contacting a naphtha feedstock with the catalyst under reforming conditions to provide an aromatized product with increased octane over the feedstock.

Additional objects, embodiments and details of this invention can be obtained from the following detailed description of the invention.

### BRIEF DESCRIPTION OF THE DRAWINGS

FIG. 1 shows alumina surface area compared to phosphorus content for samples subjected to a six-hour hydrothermal treatment.

FIG. 2 shows alumina equilibrium chloride adsorption compared to phosphorus content for samples subjected to a six-hour hydrothermal treatment.

FIG. 3 shows theta phase alumina characteristics using X-ray diffraction patterns for alumina prepared with and without dilute phosphorus.

FIG. 4 shows reforming pilot plant data comparing yields for catalysts prepared with and without dilute phosphorus.

FIG. 5 shows reforming pilot plant data comparing activity for catalysts prepared with and without dilute phosphorus.

### DETAILED DESCRIPTION OF THE INVENTION

The present invention relates to a process for preparing a catalyst. The catalyst comprises a support having dispersed thereon at least one platinum group metal component and optionally a modifier metal such as rhenium. The support can be any of a number of well-known supports in the art including aluminas, silica/alumina, titania/alumina, and zirconia/alumina. The aluminas which can be used as support include gamma alumina, theta alumina, delta alumina, and alpha alumina with gamma alumina being preferred. Included among the aluminas are aluminas that contain small amounts of modifiers such as boron, tin, zirconium, titanium and phosphate. The preferred modifier is based on a small amount of phosphorus. The supports can be formed in any desired shape such as spheres, pills, cakes, extrudates, powders, granules, etc. and they may be utilized in any particular size.

One way of preparing a spherical alumina support with a small amount of phosphorus is based on the well known oil drop method which is described in U.S. Pat. No. 2,620,314, which is incorporated by reference. The oil drop method comprises forming an aluminum hydrosol by any of the techniques taught in the art and preferably by reacting aluminum metal with hydrochloric acid and a small amount of phosphoric acid; combining the hydrosol with a suitable gelling agent; and dropping the resultant mixture into an oil bath maintained at elevated temperatures. The droplets of the mixture remain in the oil bath until they set and form hydrogel spheres. The spheres are then continuously withdrawn from the oil bath and typically subjected to specific aging and drying treatments in oil and ammoniacal solutions to further improve their physical characteristics. The resulting aged and gelled spheres are then washed and dried at a relatively low temperature of about 80° to 260° C. and then calcined at a temperature of about 455° to 705° C. for a period of about 1 to about 20 hours. This treatment effects conversion of the hydrogel to the corresponding crystalline gamma alumina comprising a dilute amount of phosphorus.

A preferred form of carrier material is a cylindrical extrudate, preferably prepared by adding and mixing the alumina powder with water and suitable peptizing agents such as HCl until an extrudable dough is formed. Preferably the peptizing agent comprises a combination of nitric acid with a dilute amount of phosphoric acid selected to provide a desired phosphorus level in a finished catalyst less than 0.4 mass-% calculated on an elemental basis, with a phosphorus range of 0.05 to 0.35 mass-% giving best results. The amount of water added to form the dough is typically sufficient to give a loss on ignition (LOI) at 500° C. of about 45 to 65 mass-%, with a value of 55 mass-% being preferred. The resulting dough is extruded through a suitably sized die to form extrudate particles. These particles are then dried at a temperature of about 260° to about 427° C. for a period of about 0.1 to 5 hours to form the extrudate particles. It is preferred that the refractory inorganic oxide comprises phosphorus and substantially pure alumina. A typical substantially pure alumina has been characterized in U.S. Pat. Nos. 3,852,190 and 4,012,313 as a by-product from a Ziegler higher alcohol synthesis reaction as described in Ziegler's U.S. Pat. No. 2,892,858.

An essential ingredient of a reforming catalyst is a dispersed platinum-group component. This platinum-group component may exist within the final catalytic composite as a compound such as an oxide, sulfide, halide, oxyhalide, etc., in chemical combination with one or more of the other ingredients of the composite or as an elemental metal. It is preferred that substantially all of this component is present in the elemental state and is uniformly dispersed within the support material. This component may be present in the final catalyst composite in any amount that is catalytically effective, but relatively small amounts are preferred. Of the platinum-group metals, which can be dispersed on the desired support, preferred metals are rhodium, palladium, platinum, and platinum being most preferred. Platinum generally comprises about 0.01 to about 2 mass-% of the final catalytic composite, calculated on an elemental basis. Excellent results are obtained when the catalyst contains about 0.05 to about 1 mass-% of platinum.

This platinum component may be incorporated into the catalytic composite in any suitable manner, such as coprecipitation or cogelation, ion-exchange, or impregnation, in order to effect a uniform dispersion of the platinum component within the carrier material. The preferred method of preparing the catalyst involves the utilization of a soluble, decomposable compound of platinum to impregnate the carrier material. For example, this component may be added to the support by commingling the latter with an aqueous solution of chloroplatinic acid. Other water-soluble compounds of platinum may be employed in impregnation solutions and include ammonium chloroplatinate, bromoplatinic acid, platinum dichloride, platinum tetrachloride hydrate, platinum dichlorocarbonyl dichloride, dinitrodiaminoplatinum, etc. The utilization of a platinum chloride compound, such as chloroplatinic acid, is preferred since it facilitates the incorporation of both the platinum component and at least a minor quantity of the halogen component in a single step. Best results are obtained in the preferred impregnation step if the platinum compound yields complex anions containing platinum in acidic aqueous solutions. Hydrogen chloride or the like acid is also generally added to the impregnation solution in order to facilitate the incorporation of the halogen component and the distribution of the metallic component. In addition, it is generally preferred to impregnate the carrier material after it has been calcined in order to minimize the risk of washing away the valuable platinum compounds; however, in some cases, it may be advantageous to impregnate the carrier material when it is in a gelled state.

Rhenium is an optional metal modifier of the catalyst. The platinum and rhenium components of the terminal catalytic composite may be composited with the refractory inorganic oxide in any manner which results in a preferably uniform distribution of these components such as coprecipitation, cogelation, coextrusion, ion exchange or impregnation. Alternatively, non-uniform distributions such as surface impregnation are within the scope of the present invention. The preferred method of preparing the catalytic composite involves the utilization of soluble decomposable compounds of platinum and rhenium for impregnation of the refractory inorganic oxide in a relatively uniform manner. For example, the platinum and rhenium components may be added to the refractory inorganic oxide by commingling the latter with an aqueous solution of chloroplatinic acid and thereafter an aqueous solution of perrhenic acid. Other water-soluble compounds or complexes of platinum and rhenium may be employed in the impregnation solutions. Typical decomposable rhenium compounds which may be employed include ammonium perrhenate, sodium perrhenate, potassium perrhenate, potassium rhenium oxychloride, potassium hexachlororhenate (IV), rhenium chloride, rhenium heptoxide, and the like compounds. The utilization of an aqueous solution of perrhenic acid is preferred in the impregnation of the rhenium component.

As heretofore indicated, any procedure may be utilized in compositing the platinum component and rhenium component with the refractory inorganic oxide as long as such method is sufficient to result in relatively uniform distributions of these components. Accordingly, when an impregnation step is employed, the platinum component and rhenium component may be impregnated by use of separate impregnation solutions or, as is preferred, a single impregnation solution comprising decomposable compounds of platinum component and rhenium component. It should be noted that irrespective of whether single or separate impregnation solutions are utilized, hydrogen chloride, nitric acid, or the like acid may be also added to the impregnation solution or solutions in order to further facilitate uniform distribution of the platinum and rhenium components throughout the refractory inorganic oxide. Additionally, it should be indicated that it is generally preferred to impregnate the refractory inorganic oxide after it has been calcined in order to minimize the risk of washing away valuable platinum and rhenium compounds; however, in some cases, it may be advantageous to impregnate refractory inorganic oxide when it is in a gelled, plastic dough or dried state. If two separate impregnation solutions are utilized in order to composite the platinum component and rhenium component with the refractory inorganic oxide, separate oxidation and reduction steps may be employed between application of the separate impregnation solutions. Additionally, halogen adjustment steps may be employed between application of the separate impregnation solutions. Such halogenation steps will facilitate incorporation of the catalytic components and halogen component into the refractory inorganic oxide.

Irrespective of its exact formation, the dispersion of platinum component and rhenium component must be sufficient so that the platinum component comprises, on an elemental basis, from about 0.01 to about 2 mass-% of the finished catalytic composite. Additionally, there must be sufficient rhenium component present to comprise, on an elemental basis, from about 0.01 to about 5 mass-% of the finished composite.

In addition to, or instead of, the rhenium catalytic component described above, other components may be added to the catalyst. For example, a modifier metal selected from the group consisting of tin, germanium, lead, indium, gallium, iridium, lanthanum, cerium, boron, cobalt, nickel, iron and mixtures thereof may be added to the catalyst. Such metal modifiers are added by the same procedure as rhenium above and in any sequence although with not necessarily the same results.

One particular method of evaporative impregnation involves the use of a steam-jacketed rotary dryer. In this method the support is immersed in the impregnating solution which has been placed in the dryer and the support is tumbled by the rotating motion of the dryer. Evaporation of the solution in contact with the tumbling support is expedited by applying steam to the dryer jacket. The impregnated support is then dried at a temperature of about 60° to about 300° C. and then calcined at a temperature of about 300° to about 850° C. for a time of about 30 minutes to about 18 hours to give the calcined catalyst. Finally, the calcined catalyst is reduced by heating the catalyst under a reducing atmosphere, preferably dry hydrogen, at a temperature of about 300° to about 850° C. for a time of about 30 minutes to about 18 hours. This ensures that the metal is in the metallic or zerovalent state.

The catalyst of the present invention has particular utility as a hydrocarbon conversion catalyst. The hydrocarbon that is to be converted is contacted with the catalyst at hydrocarbon-conversion conditions, which include a temperature of from 40° to 1000° C., a pressure of from atmospheric to 200 atmospheres absolute and liquid hourly space velocities from about 0.1 to 100 hr⁻¹. The catalyst is particularly suitable for catalytic reforming of gasoline-range feedstocks, and also may be used for, inter alia, dehydrocyclization, isomerization of aliphatics and aromatics, dehydrogenation, hydro-cracking, disproportionation, dealkylation, alkylation, transalkylation, and oligomerization.

In the preferred catalytic reforming embodiment, hydrocarbon feedstock and a hydrogen-rich gas are preheated and charged to a reforming zone containing typically two to five reactors in series. Suitable heating means are provided between reactors to compensate for the net endothermic heat of reaction in each of the reactors. Reactants may contact the catalyst in individual reactors in upflow, downflow, or radial flow fashion, with the radial flow mode being preferred. The catalyst is contained in a fixed-bed system or, preferably, in a moving-bed system with associated continuous catalyst regeneration. Alternative approaches to reactivation of deactivated catalyst are well known to those skilled in the art, and include semi-regenerative operation in which the entire unit is shut down for catalyst regeneration and reactivation or swing-reactor operation in which an individual reactor is isolated from the system, regenerated and reactivated while the other reactors remain on-stream. The preferred continuous catalyst regeneration in conjunction with a moving-bed system is disclosed, inter alia, in U.S. Pat. Nos. 3,647,680; 3,652,231; 3,692,496 and 4,832,921, all of which are incorporated herein by reference.

Effluent containing at least part of the aromatized products from the reforming zone is passed through a cooling means to a separation zone, typically maintained at about 0° to 65° C., wherein a hydrogen-rich gas is separated from a liquid stream commonly called “unstabilized reformate”. The resultant hydrogen stream can then be recycled through suitable compressing means back to the reforming zone. The liquid phase from the separation zone is typically withdrawn and processed in a fractionating system in order to adjust the butane concentration, thereby controlling front-end volatility of the resulting reformate.

Reforming conditions applied in the reforming process of the present invention include a pressure selected within the range of about 100 kPa to 7 MPa (abs). Particularly good results are obtained at low pressure, namely a pressure of about 350 to 2500 kPa (abs). Reforming temperature is in the range from about 315° to 600° C., and preferably from about 425° to 565° C. As is well known to those skilled in the reforming art, the initial selection of the temperature within this broad range is made primarily as a function of the desired octane of the product reformate considering the characteristics of the charge stock and of the catalyst. Ordinarily, the temperature then is thereafter slowly increased during the run to compensate for the inevitable deactivation that occurs to provide a constant octane product. Sufficient hydrogen is supplied to provide an amount of about 1 to about 20 moles of hydrogen per mole of hydrocarbon feed entering the reforming zone, with excellent results being obtained when about 2 to about 10 moles of hydrogen are used per mole of hydrocarbon feed. Likewise, the liquid hourly space velocity (LHSV) used in reforming is selected from the range of about 0.1 to about 20 hr⁻¹, with a value in the range of about 1 to about 5 hr⁻¹ being preferred.

The hydrocarbon feedstock that is charged to this reforming system is preferably a naphtha feedstock comprising naphthenes and paraffins that boil within the gasoline range. The preferred feedstocks are naphthas consisting principally of naphthenes and paraffins, although, in many cases, aromatics also will be present. This preferred class includes straight-run gasolines, natural gasolines, synthetic gasolines, and the like. It is also frequently advantageous to charge thermally or catalytically cracked gasolines, partially reformed naphthas, or dehydrogenated naphthas. Mixtures of straight-run and cracked gasoline-range naphthas can also be used to advantage. In some cases, it is also advantageous to process pure hydrocarbons or mixtures of hydrocarbons that have been recovered from extraction units—for example, raffinates from aromatics extraction or straight-chain paraffins—which are to be converted to aromatics.

It is generally preferred to utilize the present invention in a substantially water-free environment. Essential to the achievement of this condition in the reforming zone is the control of the water level present in the feedstock and the hydrogen stream that is being charged to the zone. Best results are ordinarily obtained when the total amount of water entering the conversion zone from any source is held to a level less than 50 ppm and preferably less than 20 ppm, expressed as weight of equivalent water in the feedstock. In general, this can be accomplished by careful control of the water present in the feedstock and in the hydrogen stream. The feedstock can be dried by using any suitable drying means known to the art such as a conventional solid adsorbent having a high selectivity for water; for instance, sodium or calcium crystalline aluminosilicates, silica gel, activated alumina, molecular sieves, anhydrous calcium sulfate, high surface area sodium, and the like adsorbents. Similarly, the water content of the feedstock may be adjusted by suitable stripping operations in a fractionation column or like device. In some cases, a combination of adsorbent drying and distillation drying may be used advantageously to effect almost complete removal of water from the feedstock. Preferably, the feedstock is dried to a level corresponding to less than 2 ppm of H₂O equivalent.

It is preferred to maintain the water content of the hydrogen stream entering the hydrocarbon conversion zone at a level of about 10 to about 20 volume ppm or less. In the cases where the water content of the hydrogen stream is above this range, this can be conveniently accomplished by contacting the hydrogen stream with a suitable desiccant such as those mentioned above at conventional drying conditions.

It is a preferred practice to use the present invention in a substantially sulfur-free environment. Any control means known in the art may be used to treat the naphtha feedstock which is to be charged to the reforming reaction zone. For example, the feedstock may be subjected to adsorption processes, catalytic processes, or combinations thereof. Adsorption processes may employ molecular sieves, high surface area silica-aluminas, carbon molecular sieves, crystalline aluminosilicates, activated carbons, high surface area metallic containing compositions, such as nickel or copper and the like. It is preferred that these feedstocks be treated by conventional catalytic pre-treatment methods such as hydrorefining, hydrotreating, hydrodesulftirization, etc., to remove substantially all sulfurous, nitrogenous and water-yielding contaminants therefrom, and to saturate any olefins that may be contained therein. Catalytic processes may employ traditional sulfur reducing catalyst formulations known to the art including refractory inorganic oxide supports containing metals selected from the group comprising Group VI-B(6), Group II-B(12), and Group VIII(IUPAC 8-10) of the Periodic Table.

### EXAMPLE 1

Phosphorus was added to the support as part of the forming process called extrusion. Six samples were prepared by adding phosphoric acid to the peptizing solution nitric acid such that the total moles of acid was approximately equivalent to 2 mass-% of the alumina powder. Thus, the amount of nitric acid used was decreased by the amount of phosphoric acid so that the total moles of acid remained about the same. Alumina powder was a blend of commercially available trade name Catapal B and trade name Versal 250. The solution was added to the alumina powder with various amounts of phosphoric acid corresponding to 0.06, 0.09, 0.18, 0.35, 0.42, and 0.51 wt-% phosphorus in the support, but where the balance of peptizing agent with nitric acid and maintained about a 2 mass-% ratio to the alumina.

After peptizing, the dough was mixed and extruded through a die plate to form extrudate particles. The extrudate particles were calcined at about 650° C. for about 2 hours. Thus, catalyst A was a reference without any phosphorus, catalyst B had 0.06 wt-%, catalyst C had 0.09 wt-%, catalyst D had 0.18 wt-%, catalyst E had 0.35 wt-%, and catalyst F had 0.42 wt-% and catalyst G had 0.51 wt-%.

### EXAMPLE 2

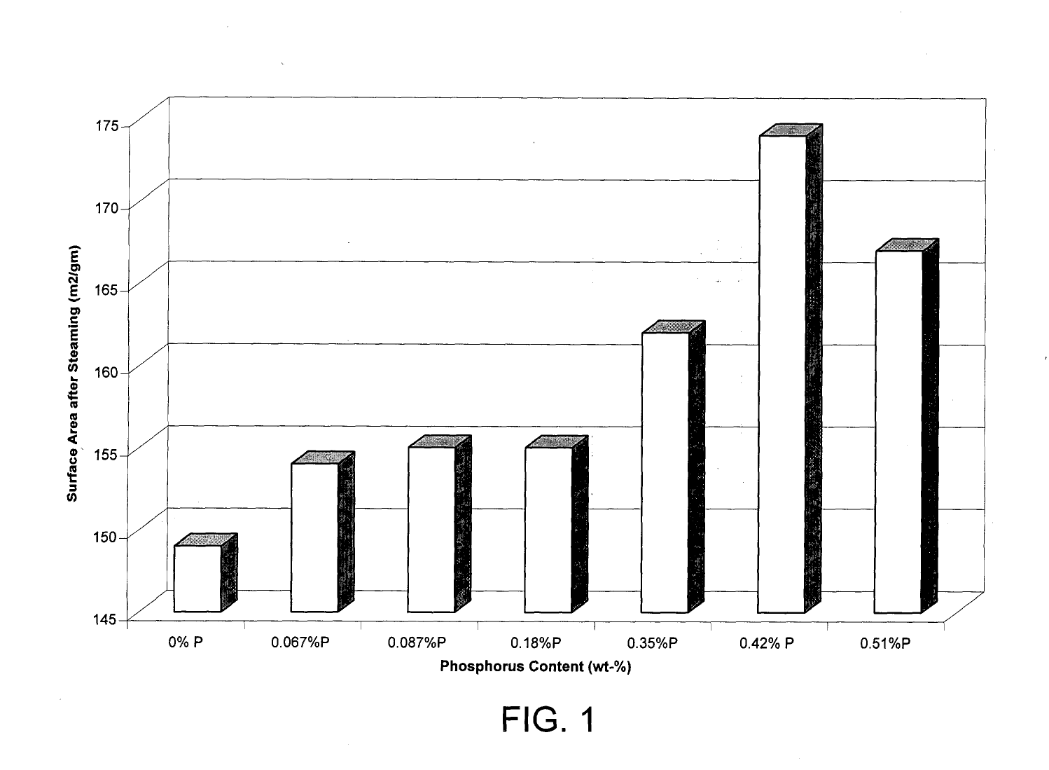

In order to gauge the effect of phosphorus content on catalyst surface area stability, the various catalysts were subjected to a hydrothermal treatment. This treatment comprised loading the catalysts into a tube furnace and subjecting them to conditions including a 725° C. temperature and 40 mol-% steam in 1000 cc/min air flow for 6 hours. The surface area of the catalysts after hydrothermal treatment were as follows: catalyst A was 149 m²/gm, catalyst B was 154 m²/gm, catalyst C was 155 m²/gm, catalyst D was 155 m²/gm, catalyst E was 162 m²/gm, catalyst F was 174 m²/gm and catalyst G was 167 m²/gm. Thus, increasing phosphorus content showed increasing surface area. This data also is shown in FIG. 1.

### EXAMPLE 3

However, higher amounts of phosphorus in an alumina support affect the ability of the catalyst to adsorb and retain chloride, which is a critical property for reforming catalysts to keep chloride while losing surface area as the catalyst ages. Thus, a stabilized catalyst must also have high chloride retention, and high amounts of phosphorus cause interference with the chloride anions.

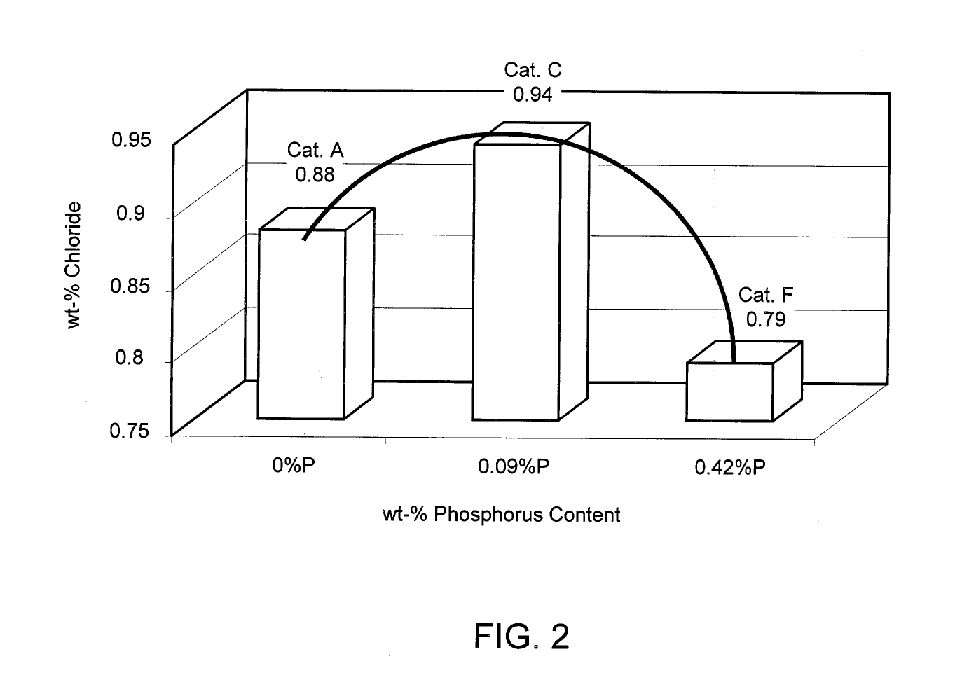

In order to investigate the ability of supports to retain chloride, catalysts A, C, and F after the hydrothermal treatment conducted in Example 2, were subsequently chlorided under the following identical conditions. The catalysts were treated in a flowing air stream containing a molar ratio of hydrochloric acid to water of 55.5 at a temperature of 525° C. until reaching equilibrium levels of chloride adsorption. The chloride after treatment was as follows: catalyst A had 0.88 wt-%, catalyst C had 0.94 wt-%, and catalyst F had 0.79 wt-%. FIG. 2 also illustrates the resulting data. It can be seen that the adsorption of chloride has a maxima near 0.09 wt-% phosphorus and clearly becomes poorer in chloride retention if the amount of phosphorus is increased from this amount. Therefore, a critical parameter of the catalyst is that the amount of phosphorus added to the alumina be less than 0.4 wt-% in order to maintain the desired chloride retention properties of the surface area stabilized support.

### EXAMPLE 4

In order to compare the performance of the dilute phosphorus containing support against alumina without phosphorus, two additional catalyst samples were created using the same extrusion method according to Example 1. Catalyst H had no phosphorus while catalyst I had 0.2 wt-% phosphorus.

First, the phase transition between gamma and theta alumina was investigated using X-ray diffraction methods. Catalysts H and I were subjected to hydrothermal treatment at 820° C. and 40% steam in 1000 cc/min air for 3 hours. The amount of gamma alumina, originally 100%, transformed into theta alumina was determined by the relative absorption intensity of the sample as compared to a theta standard.

The X-ray diffraction patterns showed characteristic intensities of peaks at specified Bragg angle positions. The X-ray pattern was obtained by standard X-ray powder diffraction techniques, the radiation source was a high-intensity, copper-target, X-ray tube operated at 45 KV and 35 mA. Flat compressed powder samples illustratively were scanned in a continuous mode with a step size of 0.030° and a dwell time of 9.0 seconds on a computer-controller diffractometer. The diffraction pattern from the copper K radiation was recorded with a Peltier effect cooled solid-state detector. The data suitably was stored in digital format in the controlling computer. The peak heights and peak positions were read from the computer plot as a function of two times theta (two-Θ), where theta is the Bragg angle. This use of ‘theta’ for X-ray diffraction should not be confused with the use of ‘theta’ for a phase of alumina, which is more highly ordered than gamma. The data comparing catalyst peak intensities against a known alumina standard is shown below.

| | Absolute Intensity | Relative Intensity |
|---|---|---|
| Catalyst H | 1.03 | 0.19 |
| Catalyst I | 0.49 | 0.09 |
| 100% Theta Alumina | 5.44 | 1.00 |

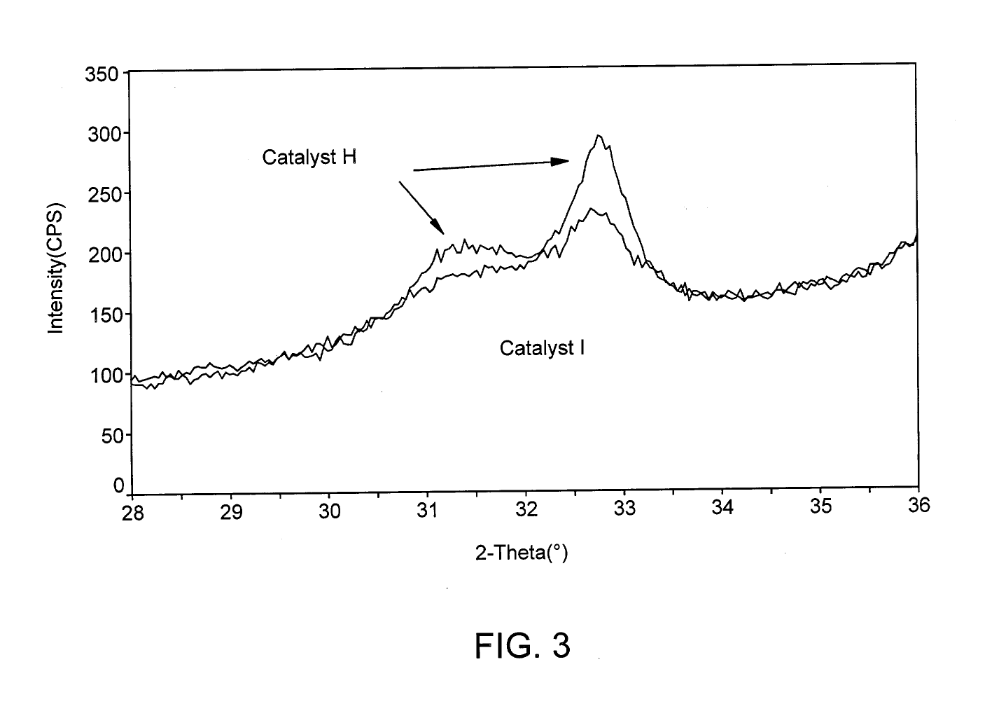

The relative intensity was closely proportional to the wt-% theta alumina content. Thus, catalyst H comprised about 19 wt-% theta alumina and catalyst I comprised about 9 wt-% theta alumina. FIG. 3 shows the peak intensity difference between a 31 to 33 two-Θ Bragg angle range and clearly indicates the increasing theta phase character of the alumina support. Such theta phase character evidences a more compact and highly ordered phase of alumina with consequent lower surface area. Catalyst I with more gamma alumina content should be a better reforming catalyst with more useful surface area.

In order to compare the performance between catalyst H and catalyst I under naphtha reforming conditions, both catalysts were loaded with 0.3 wt-% platinum. The catalysts were individually placed in a rotary evaporator and heated to 60° C. A solution comprising deionized water, hydrochloric acid, chloroplatinic acid was added to the rotary evaporator and temperature was raised to 100° C. and the support rolled for 5 hours. Next the impregnated catalysts were heated to a temperature of 525° C. in dry air. When the temperature was reached, an air stream containing HCl and Cl₂ was flowed through the catalysts for 6 hours. Finally, the catalysts were reduced by flowing pure hydrogen over the catalyst at a temperature of 510° C. for 2.5 hours. Analysis of catalyst H showed it to contain 0.85 wt-% chloride and catalyst I had 0.89 wt-% chloride.

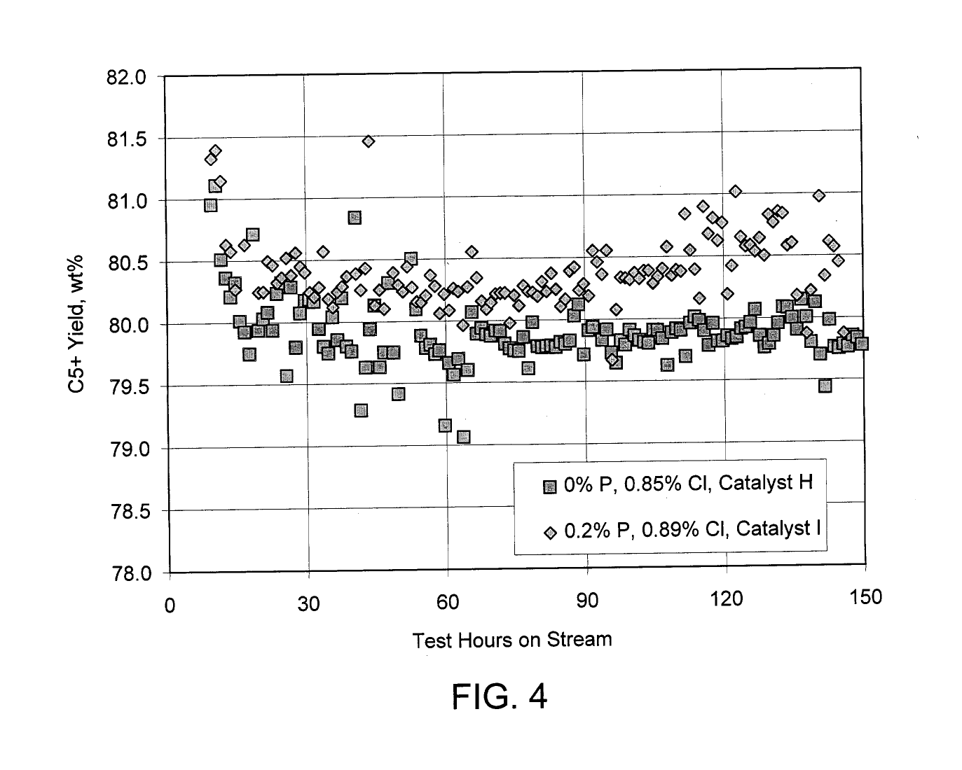

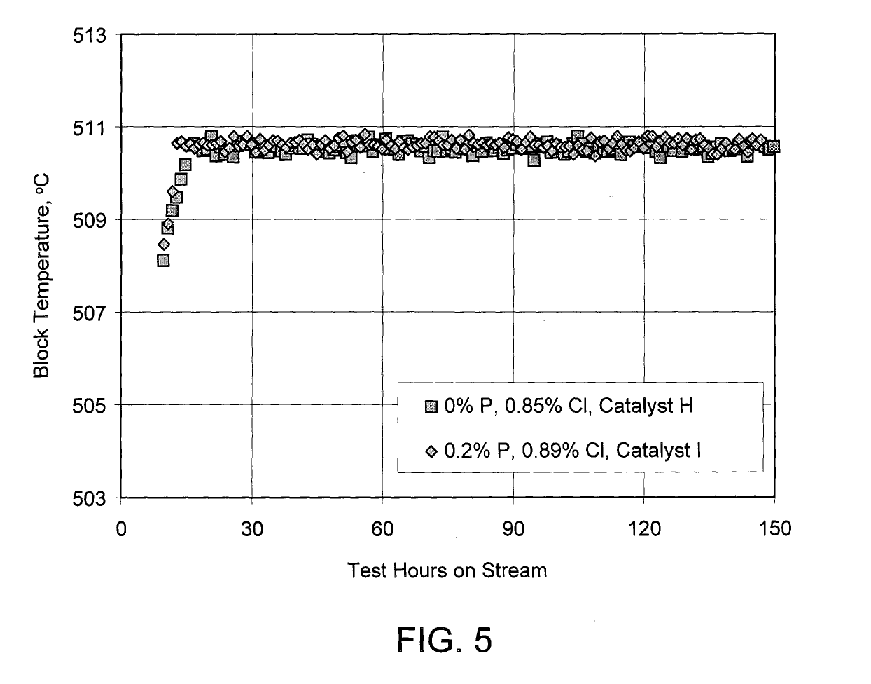

Both catalysts were loaded into downflow pilot plant reactors and individually tested by contact with a mid-range naphtha feedstock under conditions of about 1900 kPa, 1.8 liquid hourly space velocity, 2.0 hydrogen to hydrocarbon recycle gas ratio, with a target product octane of about 99. Results from the pilot plant tests are shown in FIG. 4 and FIG. 5. FIG. 4 shows liquid yields of C₅⁺ material for catalyst I to be better than yields for catalyst H. While FIG. 5 shows that both catalysts have similar activity by reactor block temperature measurements.

Therefore, naphtha reforming pilot plant testing data clearly indicates that catalyst I with 0.2 wt-% phosphorus operated at equivalent activity and better yields than a reference catalyst H prepared without dilute phosphorus incorporation.

1. A process for preparing a reforming catalyst with stabilized surface-area comprising an alumina support and a phosphorus component present in an amount from greater than 0 wt-% and less than about 0.4 wt-% calculated on an elemental basis, characterized in that after steaming the catalyst with air comprising about 40 mol-% water for about 6 hours at about 725° C., the catalyst has a surface area greater than about 150 m²/gm and has an equilibrium level of chloride absorption greater than about 0.8 wt-%, the process comprising adding a peptizing acid comprising dilute phosphoric acid to an alumina powder to form a dough, mixing said dough, extruding said dough to form extrudate particles, calcining said extrudate particles under calcination conditions, and dispersing a platinum group component on said extrudate particles in order to produce said catalyst.

2. The process of claim 1 wherein the phosphorus content of the catalyst varies from about 0.05 wt-% to about 0.35 wt-% of the catalyst calculated on an elemental basis.

3. The process of claim 1 wherein the calcination conditions comprises a temperature between about 300° and about 850° C. for a time of about 30 minutes to about 18 hours.

4. The process of claim 1 wherein the alumina powder further comprises an alumina modifier selected from the group consisting of boron, titanium, silicon, zirconium, and mixtures thereof.

5. The process of claim 1 wherein the peptizing acid further comprises nitric acid.

6. The process of claim 1 wherein the alumina powder prior to the addition of the peptizing agent is gamma phase alumina.

7. The process of claim 6 wherein the catalyst is further characterized in that after steaming less than 10 wt-% of the gamma phase alumina has changed into theta phase alumina.

8. The process of claim 1 wherein the equilibrium level of chloride adsorption is greater than about 0.9 wt-%.

9. The product of the process of claim 1.

10. A reforming catalyst with stabilized surface-area comprising an alumina support having dispersed thereon a platinum group component, an optional metal modifier component, a halogen component, and a phosphorus component, the phosphorus component present in an amount from about 0.05 to about 0.35 wt-%, characterized in that after steaming with air comprising about 40 mol-% water for about 6 hours at about 725° C., the catalyst has a surface area greater than about 150 m²/gm and has an equilibrium level of chloride absorption greater than about 0.8 wt-%, wherein the catalyst is prepared by a process comprising adding a peptizing acid comprising dilute phosphoric acid to an alumina powder to form a dough, mixing said dough, extruding said dough to form extrudate particles, calcining said extrudate particles under calcination conditions, and dispersing the platinum group component on said extrudate particles in order to produce said catalyst.

11. The catalyst of claim 10 wherein the platinum group component is platinum and is present in an amount from about 0.01 to about 2.0 wt-% calculated on an elemental basis.

12. The catalyst of claim 10 wherein the optional metal modifier component is selected from the group consisting of tin, rhenium, germanium, lead, indium, gallium, iridium, lanthanum, cerium, boron, cobalt, nickel, iron, and mixtures thereof, and is present in an amount from about 0.01 to about 5.0 wt-% calculated on an elemental basis.

13. The catalyst of claim 10 wherein the equilibrium level of chloride adsorption is greater than about 0.9 wt-%.

14. The catalyst of claim 10 wherein the alumina support after steaming is at least 90 wt-% gamma phase.

15. The catalyst of claim 10 wherein the surface area is greater than about 155 m²/gm.

16. The catalyst of claim 10 further comprising an alumina modifier selected from the group consisting of boron, titanium, silicon, zirconium, and mixtures thereof.

17. A reforming process comprising contacting a naphtha feedstock with a stabilized surface-area catalyst under reforming conditions to provide an aromatized product with increased octane over the feedstock, the catalyst comprising an alumina support having dispersed thereon a platinum group component, an optional metal modifier component, a halogen component, and a phosphorus component, the phosphorus component present in an amount from about 0.05 to about 0.35 wt-%, characterized in that after steaming with air comprising about 40 mol-% water for about 6 hours at about 725° C., the catalyst has a surface area greater than about 150 m²/gm and has an equilibrium level of chloride absorption greater than about 0.8 wt-%, wherein the catalyst is prepared by a process comprising adding a peptizing acid comprising dilute phosphoric acid to an alumina powder to form a dough, mixing said dough, extruding said dough to form extrudate particles, calcining said extrudate particles under calcination conditions, and dispersing the platinum group component on said extrudate particles in order to produce said catalyst.

18. The process of claim 17 wherein the reforming conditions comprise a pressure of about 100 kPa to about 7 MPa (abs), a temperature of about 315° to about 600° C., and a liquid hourly space velocity of about 0.1 to about 20 hr⁻¹.

19. The process of claim 18 wherein the reforming conditions further comprise a substantially water-free environment.

20. The process of claim 17 wherein the platinum group component is platinum and is present in an amount from about 0.01 to about 2.0 wt-% calculated on an elemental basis.

21. The process of claim 17 wherein the equilibrium level of chloride adsorption is greater than about 0.85 wt-%.

22. The process of claim 17 wherein the naphtha feedstock is substantially sulfur free.
